(19) United States
(12) Patent Application Publication
(10) Pub. No.: US 2008/0170482 A1
(43) Pub. Date: Jul. 17, 2008

(54) METHOD AND APPARATUS FOR IDENTIFYING OPTICAL DISC'S TYPE

(76) Inventors: Chi-Mou Chao, Hsinchu County (TW); Yu-Chun Lin, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/623,298

(22) Filed: Jan. 15, 2007

(51) Int. Cl. G11B 19/12

(52) U.S. Cl. 369/53.22

(57) ABSTRACT

A method for identifying an optical disc's type includes: detecting at least one header's appearance according to a reproduced signal in an optical storage device accessing the optical disc; after the appearance of a first header of the at least one header is detected, detecting whether there is another header's appearance in a window that lags behind the first header's appearance; and determining whether the optical disc is a DVD-RAM disc according to the number of times that there is a header's appearance in a corresponding window.

### BACKGROUND

The present disclosure relates to optical storage techniques, and more particularly, to methods and apparatuses for identifying an optical disc's type.

Conventionally, identification of a Digital Versatile Disc Random Access Memory (DVD-RAM) disc can be implemented by counting the number of headers during one rotation of the DVD-RAM disc while an optical pickup (OPU) of an optical disc drive accessing the DVD-RAM disc is in a track-on status and also in a track-on status. According to the related art, the architecture for header recognition in the optical disc drive should be enabled, which takes a lot of efforts and times. Worst of all, as the header recognition is not always accurate, the optical disc drive may fail to count the number of headers accurately. As a result, erroneously identifying the DVD-RAM disc as an optical disc of another type or erroneously identifying a non DVD-RAM disc as a DVD-RAM disc may occur.

### SUMMARY

It is an objective of the claimed invention to provide methods and apparatuses for identifying an optical disc's type.

An exemplary embodiment of a method for identifying an optical disc's type comprises: detecting at least one header's appearance according to a reproduced signal in an optical storage device accessing the optical disc; after the appearance of a first header of the at least one header is detected, detecting whether there is another header's appearance in a window that lags behind the first header's appearance; and determining whether the optical disc is a DVD-RAM disc according to the number of times that there is a header's appearance in a corresponding window.

An exemplary embodiment of an apparatus for identifying an optical disc's type comprises: a header appearance detection module; and a decision unit, coupled to the header appearance detection module. The header appearance detection module is utilized for detecting at least one header's appearance according to a reproduced signal in an optical storage device accessing the optical disc. After the appearance of a first header of the at least one header is detected, the decision unit detects whether there is another header's appearance in a window that lags behind the first header's appearance. In addition, the decision unit determines whether the optical disc is a DVD-RAM disc according to the number of times that there is a header's appearance in a corresponding window.

According to one aspect of one embodiment of the claimed invention, the apparatus is substantially the optical storage device. According to another aspect of the embodiment of the claimed invention, the apparatus is a circuit positioned in the optical storage device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified block diagram of an optical storage device according to an embodiment of the present invention.

FIG. 2 is a schematic diagram illustrating the corresponding positions of the detection signals A through H with respect to the photo detector shown in FIG. 1.

FIG. 3 illustrates typical waveforms of the reproduced signal and the reference signal utilized according to the embodiment shown in FIG. 1.

FIG. 4 illustrates a plurality of states of a state machine in the decision unit shown in FIG. 1 according to one embodiment of the present invention.

FIG. 5 illustrates a plurality of windows and corresponding parameters utilized by the decision unit shown in FIG. 1 according to one embodiment of the present invention.

FIG. 6 and FIG. 7 illustrate two portions of a flowchart of a method for identifying an optical disc's type according to one embodiment of the present invention.

FIG. 8 illustrates a plurality of states of a state machine in the decision unit shown in FIG. 1 according to one embodiment of the present invention.

FIG. 9 illustrates a flowchart of a method for identifying an optical disc's type according to one embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

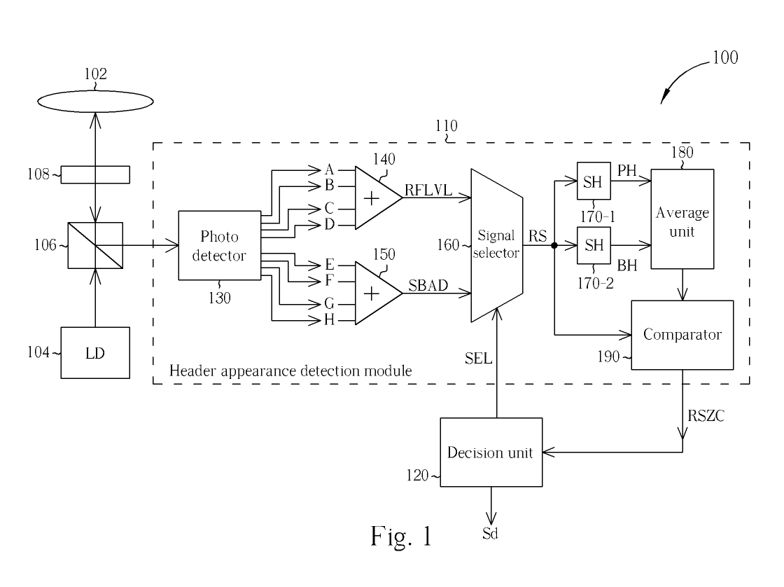

Please refer to FIG. 1, which shows a simplified block diagram of an optical storage device 100 according to an exemplary embodiment, where the optical storage device 100 is capable of accessing an optical disc 102 loaded therein. As shown in FIG. 1, the optical storage device 100 comprises: a laser diode 104, a beam splitter 106, a lens module 108, a header appearance detection module 110, and a decision unit 120, where the decision unit 120 of this embodiment comprises a state machine (not shown) therein. The operations of the laser diode 104, the beam splitter 106, and the lens module 108 are well known in the art, further details are therefore omitted herein for the sake of brevity.

According to this embodiment, the header appearance detection module 110 is utilized for detecting at least one header's appearance according to a reproduced signal in the optical storage device 100 accessing the optical disc 102, and further generating a reference signal corresponding to the reproduced signal to represent the detection result of the at least one header's appearance. More particularly, the header appearance detection module 110 generates the reference signal RSZC corresponding to the reproduced signal RS as shown in FIG. 1, where the reproduced signal RS of this embodiment carries information corresponding to appearances of headers read from the optical disc 102. According to the reference signal RSZC corresponding to the reproduced signal RS, the decision unit 120 may identifying the optical disc's type, and more particularly, the decision unit 120 is capable of determining whether the optical disc 102 is a DVD-RAM disc (or a non DVD-RAM disc). It is noted that according to another embodiment of this invention, an IDGATE signal can be utilized as the reference signal or utilized for generating the reference signal for use of identifying the optical disc's type.

As shown in FIG. 1, the header appearance detection module 110 of this embodiment comprises a photo detector 130, two operating units 140 and 150, a signal selector 160, two sample/hold circuits 170-1 and 170-2, an average unit 180, and a comparator 190. It is noted that a combination of at least the laser diode 104, the beam splitter 106, the lens module 108, and a portion of the header appearance detection module 110, for example, the photo detector 130, even together with the operating units 140 and 150, is typically considered to be an optical pickup (OPU) of the optical disc drive 100.

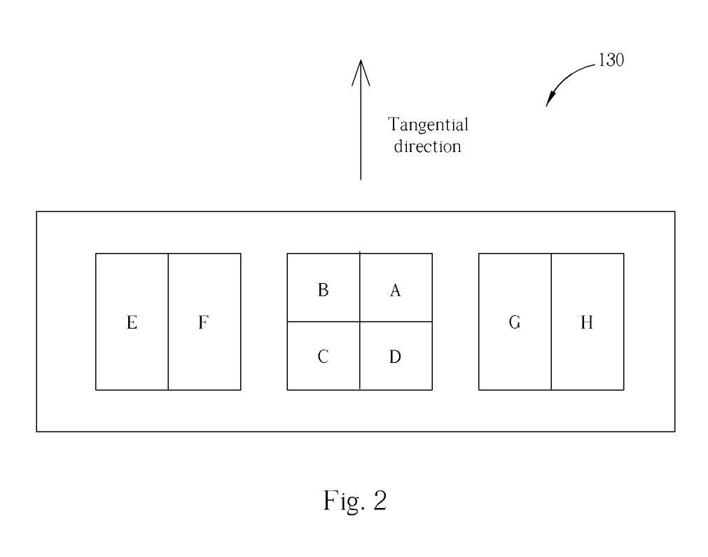

According to this embodiment, the photo detector 130 is arranged for detecting light reflected from the optical disc 102 to generate detection signals A, B, C, D, E, F, G, and H, where the detection signals A through D correspond to the reflected light of the main beam while the detection signals E through H correspond to the reflected light of the side beam. In addition, the corresponding positions of the detection signals A through H with respect to the photo detector 130 are illustrated in FIG. 2. In practice, the photo detector 130 may be implemented by a photo detector integrated circuit (PDIC). Additionally, the first operating unit 140 is arranged for generating a main beam sum signal RFLVL according to the detection signals A through D, and the second operating unit 150 is arranged for generating a side beam sum signal SBAD according to the detection signals E through H. In practice, the signal selector 160 may be a multiplexer for selectively outputting either the main beam sum signal RFLVL or the side beam sum signal SBAD as the reproduced signal RS according to a selection signal SEL outputted from the decision unit 120. As a result of this arrangement shown in FIG. 1, the reproduced signal RS corresponds to the reflected light of the main beam or the reflected light of the side beam in the optical storage device 100. It is noted that either the main beam sum signal RFLVL or the side beam sum signal SBAD carries information corresponding to the headers' appearances mentioned above.

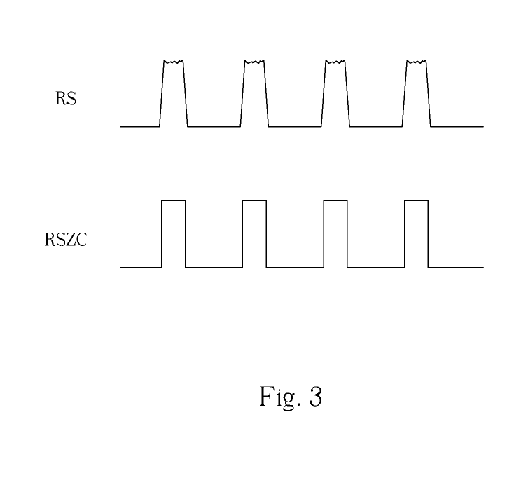

In this embodiment, a slice level generator comprising the two sample/hold circuits 170-1 and 170-2 and the average unit 180 shown in FIG. 1 is utilized for generating a slice level signal SL. The sample/hold circuits 170-1 and 170-2 perform sample/hold operations on the reproduced signal RS outputted from the signal selector 160 to generate a peak hold signal PH and a bottom hold signal BH, respectively. The average unit 180 averages the peak hold signal PH and the bottom hold signal BH respectively outputted from the sample/hold circuits 170-1 and 170-2 to generate the slice level signal SL, and the comparator 190 compares the reproduced signal RS with the slice level signal SL to generate the reference signal RSZC, where typical waveforms of the reproduced signal RS and the reference signal RSZC are illustrated as shown in FIG. 3.

According to the foregoing descriptions, it can be appreciated that both the combination of the photo detector 130 and the operating unit 140 and the combination of the photo detector 130 and the operating unit 150 can be utilized for generating the reproduced signal RS, and the combination of the comparator 190 and the slice level generator (which comprises the two sample/hold circuits 170-1 and 170-2 and the average unit 180 in this embodiment) converts the reproduced signal RS into a better format (i.e., the reference signal RSZC) for use of detecting and monitoring the headers' appearances. Regarding the situation when the optical disc 102 is a DVD-RAM disc, as the reflectance corresponding to header areas is typically greater than that corresponding to the others in a focus-on status of the OPU mentioned above while the optical disc 102 is not polluted or scratched, regular appearances of the headers can be detected according to the reproduced signal RS, and more particularly, according to the better format of the reproduced signal RS, i.e. the reference signal RSZC.

For simplicity, in the following embodiments of the present invention, the reproduced signal RS is described as the main beam sum signal RFLVL, and the reference signal RSZC is described as the reference signal RFLZC corresponding the main beam sum signal RFLVL. Those skilled in the art will appreciate that in other embodiments of the present invention, the reproduced signal RS can be described as the side beam sum signal SBAD, and the reference signal RSZC is described as the reference signal SBZC corresponding the side beam sum signal SBAD.

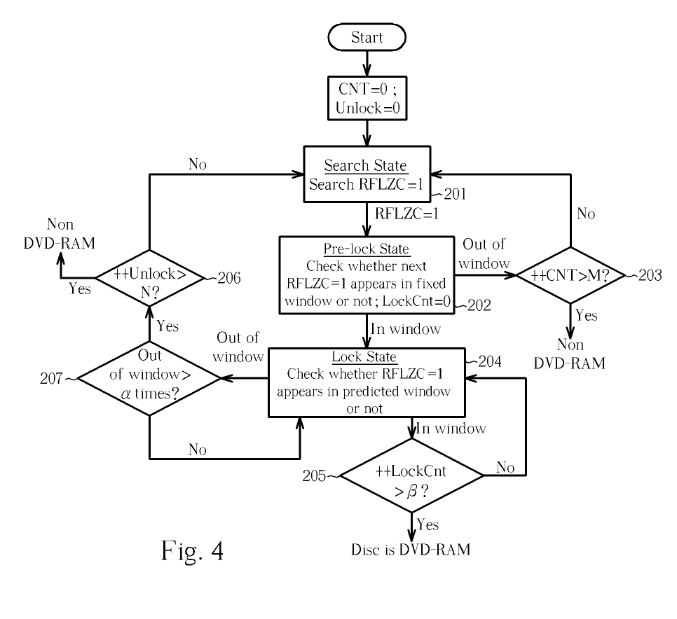

FIG. 4 illustrates a plurality of states of the state machine mentioned above according to one embodiment of the present invention, where the operations shown in FIG. 4 can be applied to the embodiment shown in FIG. 1. Hereinafter, some pseudo codes are utilized in related descriptions and figures for better understanding to those skilled in the art. For example, in Step 203, the operations “++CNT>M” means first increasing the counter value CNT with an increment of one and then comparing the counter value CNT with the threshold M, in order to determine whether the counter value CNT is greater than the threshold M.

According to this embodiment, before the state machine enters a Search State corresponding to Step 201, the counter values CNT and Unlock are set to be zero at first. In Step 201, search any header's appearance according to the reference signal RFLZC. According to this embodiment, “RFLZC=1” represents the situation that the reference signal RFLZC is at a high level, which means a header's appearance is detected. Conversely, “RFLZC=0” represents the situation that the reference signal RFLZC is at a low level, which means no header's appearance is detected. Once the situation that the reference signal RFLZC is at the high level is detect, the state machine enters a Pre-lock State corresponding to Step 202.

In Step 202, check the next header's appearance in a fixed window or not according to the reference signal RFLZC, and further set the counter value LockCnt to be zero. In this embodiment, the state machine of the decision unit 120 detects whether there is another header's appearance in the fixed window that lags behind the first header's appearance, where the fixed window is determined according to the rotational speed of the optical disc 102 and the location of the OPU of the optical storage device 100.

If there is no header's appearance in the fixed window, enter Step 203, where the operations “++CNT>M” of Step 203 are explained as mentioned above. Once the counter value CNT is greater than the threshold M, the state machine of the decision unit 120 determines the optical disc 102 is a non DVD-RAM disc; otherwise, the state machine reenters the Search State corresponding to Step 201.

In Step 202, if there is a header's appearance in the fixed window, the state machine enters the Lock State corresponding to Step 204. According to this embodiment, instead of a fixed window such as that utilized in the Pre-lock State, at least one predicted window is utilized in the Lock State. The state machine of the decision unit 120 detects whether there is another header's appearance in a predicted window that lags behind the previous header's appearance, where the predicted window can be determined according to the interval between two previous headers' appearances, for example, the interval between the first header's appearance detected in the Search State and the second header's appearance detected in the Pre-lock State, or the interval between two headers' appearances that have been detected previously in Step 204. Here, once a header's appearance is detected in a predicted window, enter Step 205.

In Step 205, once the counter value LockCnt is greater than the threshold β, the state machine of the decision unit 120 determines the optical disc 102 is a DVD-RAM disc; otherwise, the state machine reenters the Lock State corresponding to Step 204.

In Step 204, once there is no header's appearance in a predicted window, enter Step 207. In Step 207, once the number of times that there is no header's appearance in a predicted window is greater than the threshold α, enter Step 206; otherwise, reenter Step 204.

In Step 206, once the counter value Unlock is greater than the threshold N, the state machine of the decision unit 120 determines the optical disc 102 is a non DVD-RAM disc; otherwise, the state machine reenters the Search State corresponding to Step 201.

According to a variation of the embodiment shown in FIG. 4, the threshold α can be set to be one, which means Step 207 can be omitted, and therefore in Step 204, once there is no header's appearance in a predicted window, enter Step 206.

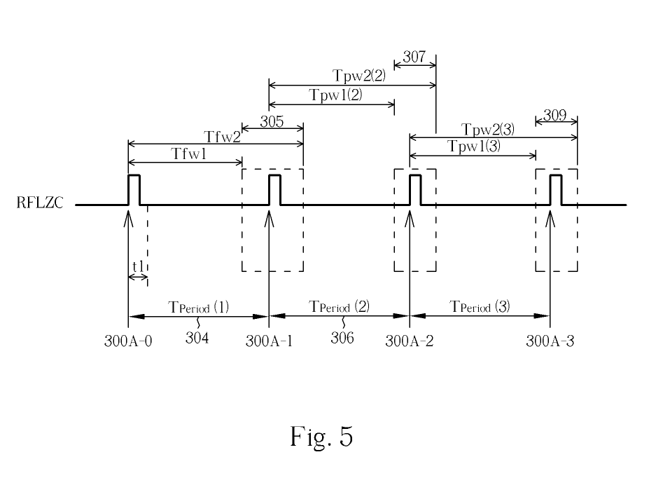

FIG. 5 illustrates a plurality of windows 305, 307, and 309 and corresponding parameters Tfw1, Tfw2, Tpw1(2), Tpw2(2), Tpw1(3), and Tpw2(3) utilized by the decision unit 120 shown in FIG. 1 according to one embodiment of the present invention, where the windows and the corresponding parameters mentioned above can be applied to the embodiment shown in FIG. 1 together with the embodiment shown in FIG. 4. According to this embodiment, the time points when rising edges of pulses of the reference signal RFLZC are detected, for example, the time points 300A-0, 300A-1, 300A-2, and 300A-3 shown in FIG. 5, represent the headers' appearances. In addition, the window 305 is a fixed window, while the windows 307 and 309 are predicted windows. The parameters Tfw1 and Tfw2 corresponding to the fixed window 305 are determined according to the rotational speed of the optical disc 102 and the location of the OPU of the optical storage device 100, where the difference (Tfw2−Tfw1) represents the width of the fixed window, and the average (Tfw2+Tfw1)/2 represents the relative time of the fixed window 305 with respect to the first header's appearance. On the other hand, the parameters Tfw1(k) and Tfw2(k) can be determined according to the interval between two previous headers' appearances, where k=2, 3, . . . and so on. Typically, the parameters Tfw1(k) and Tfw2(k) can be derived as follows:

Tfw1(k)=T_{Period}(k−1)−IDW1; and

Tfw2(k)=T_{Period}(k−1)+IDW2;

where the parameters IDW1 and IDW2 are predetermined values for defining a common width of the predicted windows.

At the time point 300A-0, the state machine of the decision unit 120 resets a timer to start timing the interval T_{Period}(1). According to this embodiment, a delay time t1 can be applied for delaying the beginning of the Pre-lock State, in order to mask the first pulse of the reference signal RFLZC shown in FIG. 5. Once the situation that the second header's appearance is in the fixed window 305 (i.e., Tfw1<T_{Period}(1)<Tfw2) is detected, the state machine enters the Lock State and resets the timer to start timing the interval T_{Period}(2). Once the situation that the third header's appearance is in the predicted window 307 (i.e., Tpw1(2)<T_{Period}(2)<Tpw2(2)) is detected, the headers' appearances are considered to be locked, and the state machine resets the timer to start timing the interval T_{Period}(3). If the headers' appearances are locked over β times as mentioned in Step 205, the state machine determines that the optical disc 102 is a DVD-RAM disc.

It is noted that the relative time of the fixed window 305 with respect to the first header's appearance is independent of any header's appearance, and the relative time of the predicted windows 307 and the relative time of the predicted windows 309 are predicted according to the intervals T_{Period}(1) and T_{Period}(2), respectively. If a specific predicted windows of the predicted windows in the Lock State exceeds a candidate fixed window having the same parameters Tfw1 and Tfw2 as those of the fixed window 305, that is, Tpw1(k)<Tfw1 and/or Tpw2(k)>Tfw2, the state machine of the decision unit 120 replaces the specific predicted windows with the candidate fixed window.

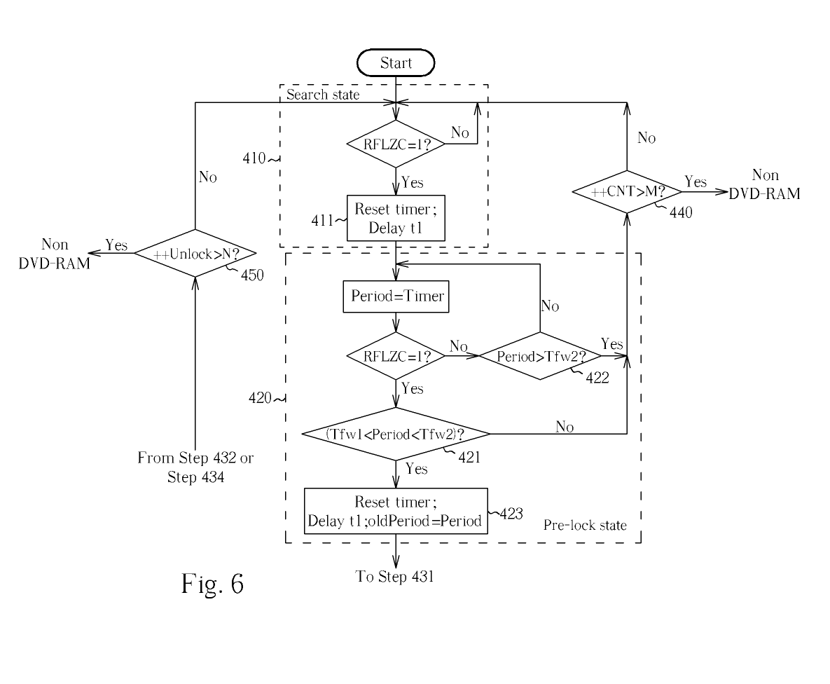

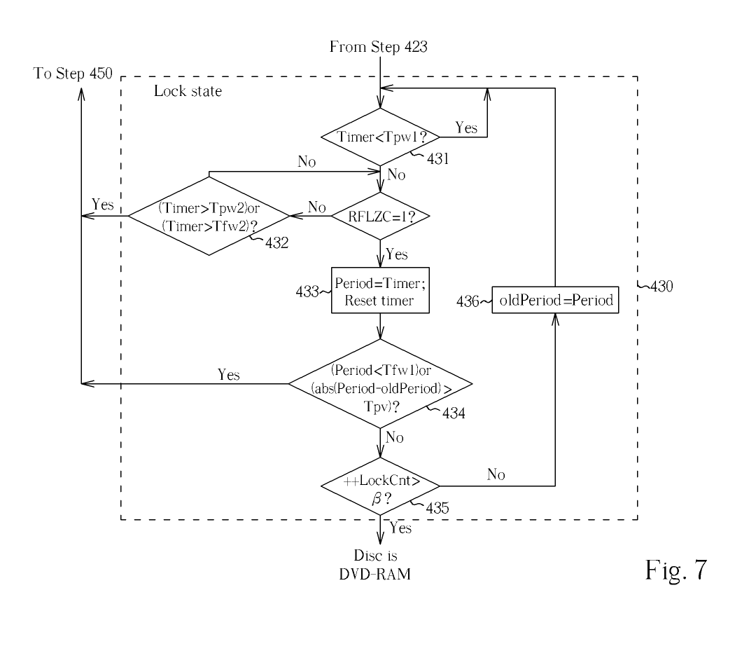

Please refer to FIG. 6 and FIG. 7, which illustrate two portions of a flowchart of a method for identifying an optical disc's type according to one embodiment of the present invention, where the method can be applied to the embodiment shown in FIG. 1 together with the embodiment shown in FIG. 4. In the Search State 410, the pseudo code “RFLZC=1” means the operations of detecting the first header's appearance mentioned above, and therefore not repeated in detail here. In Step 411, the operations of resetting the timer and delaying with the delay amount t1 are both explained as mentioned.

In the Pre-lock State 420, two parameters Period and oldPeriod are involved, where the parameter Period is utilized for retrieving the latest value Timer of the timer, and the parameter oldPeriod is utilized for temporarily storing the value of the parameter Period for comparisons of different header periods corresponding to the headers' appearances. For example, parameters Period and oldPeriod can be utilized for respectively representing the intervals T_{Period}(k) and T_{Period}(k−1).

In the Pre-lock State 420, the pseudo code “Period=Timer” means the operation of retrieving the latest value Timer of the timer mentioned above. Afterward, if a header's appearance is detected, the state machine enters Step 421; otherwise, the state machine enters Step 422.

In Step 422, if the parameter Period is greater than the parameter Pfw2, the state machine enters Step 440 to determine whether the optical disc 102 is a non DVD-RAM disc according to the counter value CNT and the threshold M mentioned above; otherwise, the state machine retrieves the latest value Timer of the timer.

In Step 421, the state machine checks whether the recently detected header's appearance is in a fixed window such as the fixed window 305 mentioned above. If the recently detected header's appearance is in the fixed window, the state machine enters Step 423; otherwise, the state machine enters Step 440.

In Step 423, the state machine resets the timer and delay with the delay amount t1 as mentioned, and save the value of the parameter Period into the parameter old period.

In the Lock State 430, the operations of comparing the latest value Timer of the timer with the parameter Tpw1 (e.g., Tpw1(2), Tpw1(3), . . . etc.), the parameter Tpw2 (e.g., Tpw2(2), Tpw2(3), . . . etc.), and the parameter Tfw2 respectively in Step 431 and Step 432 are utilized for determining whether the recently detected header's appearance is in a predicted window. In addition, the operation of comparing the parameter Period with the Tfw1 in Step 434 is utilized for determining whether the header's appearance is in a candidate fixed window such as the candidate fixed window mentioned above. Additionally, the operation of comparing the difference (Period−oldPeriod) with the parameter Tpv is utilized for determining whether the difference between two intervals such as the difference (T_{Period}(k)−T_{Period}(k−1)) is greater than the threshold Tpv (which is a predetermined value in this embodiment), in order to determine whether the headers' appearances are regular.

As a result, if the headers' appearances are not regular, Step 450 will be entered more than once. In Step 450, once the parameter Unlock, which represents the number of times that the headers' appearances are not locked, is greater than the threshold N, the state machine determines the optical disc 102 is a non DVD-RAM disc.

Conversely, if the headers' appearances are regular, Step 435 will be entered more than once. In Step 435, once the parameter LockCnt, which represents the number of times that the headers' appearances are locked, is greater than the threshold β, the state machine determines the optical disc 102 is a DVD-RAM disc.

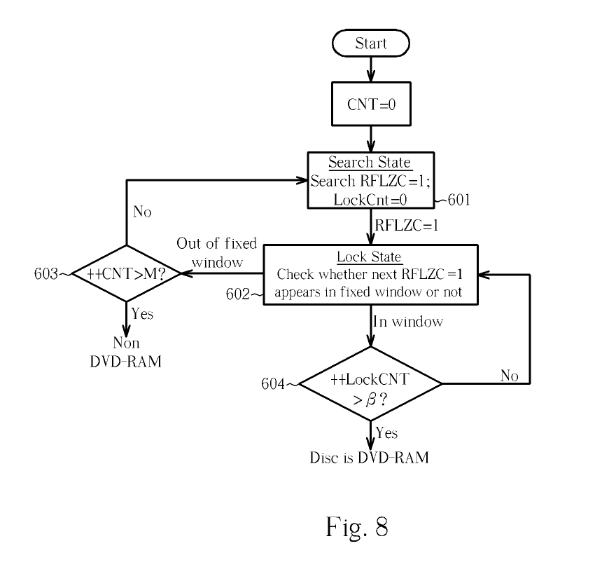

FIG. 8 illustrates a plurality of states of a state machine in the decision unit shown in FIG. 1 according to one embodiment of the present invention, where the operations shown in FIG. 8 can be applied to the embodiment shown in FIG. 1. The embodiment shown in FIG. 8 is a variation of the embodiment shown in FIG. 4. In this variation, the Pre-lock State mentioned above is omitted for simplicity. In addition, no predicted window is utilized in this variation, while the windows for detecting the headers' appearances are all fixed windows. Similar descriptions of this variation are not repeated here.

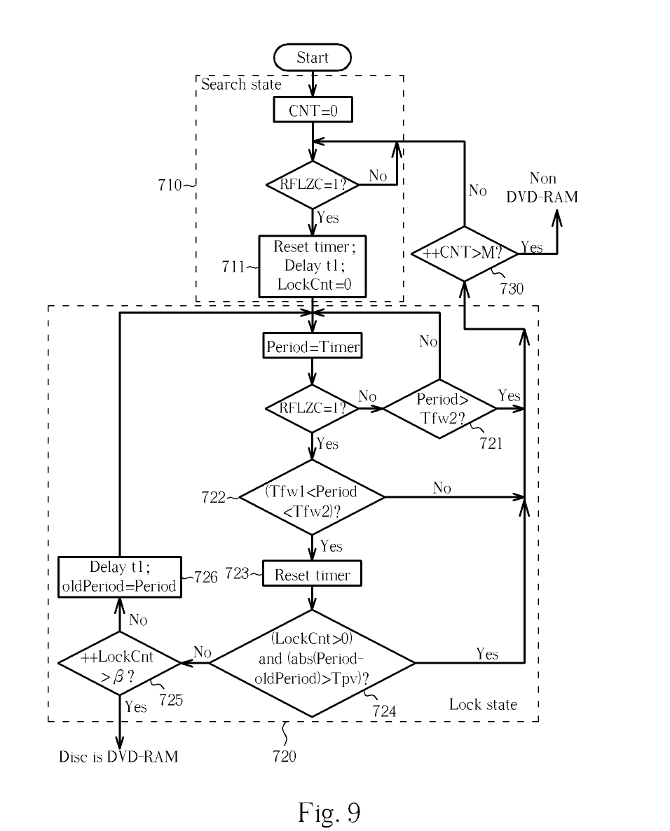

FIG. 9 illustrates a flowchart of a method for identifying an optical disc's type according to one embodiment of the present invention, where the method can be applied to the embodiment shown in FIG. 1 together with the embodiment shown in FIG. 8. The embodiment shown in FIG. 9 is a variation of the embodiment shown in FIG. 6 and FIG. 7. In this variation, the Pre-lock State mentioned above is omitted for simplicity, and the windows for detecting the headers' appearances are all fixed windows. Similar descriptions of this variation are not repeated here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for identifying an optical disc's type, comprising:
detecting at least one header's appearance according to a reproduced signal in an optical storage device accessing the optical disc;
after the appearance of a first header of the at least one header is detected, detecting whether there is another header's appearance in a window that lags behind the first header's appearance; and
determining whether the optical disc is a DVD-RAM disc according to the number of times that there is a header's appearance in a corresponding window.

2. The method of claim 1, wherein the reproduced signal carries information corresponding to the headers' appearances.

3. The method of claim 1, wherein the reproduced signal corresponds to the reflected light of the main beam in the optical storage device.

4. The method of claim 1, wherein the reproduced signal corresponds to the reflected light of the side beam in the optical storage device.

5. The method of claim 1, the step of detecting the at least one header's appearance according to the reproduced signal in the optical storage device accessing the optical disc further comprises: generating a reference signal corresponding to the reproduced signal to represent the detection result of the at least one header's appearance.

6. The method of claim 1, wherein an IDGATE signal is utilized as the reference signal or utilized for generating the reference signal.

7. The method of claim 1, wherein the step of detecting whether there is another header's appearance in the window that lags behind the first header's appearance further comprises:
after the first header's appearance is detected, if there is a second header's appearance in the window that lags behind the first header's appearance, detecting whether there is another header's appearance in a window that lags behind the second header's appearance.

8. The method of claim 7, wherein the step of detecting whether there is another header's appearance in the window that lags behind the first header's appearance further comprises:
determining the window that lags behind the second header's appearance according to the interval between the first header's appearance and the second header's appearance.

9. The method of claim 1, wherein the step of detecting whether there is another header's appearance in the window that lags behind the first header's appearance further comprises:
determining the window that lags behind the first header's appearance according to the rotational speed of the optical disc and the location of an optical pickup of the optical storage device.

10. The method of claim 1, wherein the step of detecting whether there is another header's appearance in the window that lags behind the first header's appearance further comprises:
regarding each window for detecting whether there is a header's appearance in the window, determining the window according to the rotational speed of the optical disc and the location of an optical pickup of the optical storage device.

11. The method of claim 1, wherein the step of determining whether the optical disc is a DVD-RAM disc further comprises:
determining whether the optical disc is a DVD-RAM disc according to the number of times that there is no header's appearance in a window.

12. The method of claim 1, wherein the step of determining whether the optical disc is a DVD-RAM disc further comprises:
determining whether the optical disc is a DVD-RAM disc according to the number of subsequently detected headers' appearances.

13. An apparatus for identifying an optical disc's type, comprising:
a header appearance detection module for detecting at least one header's appearance according to a reproduced signal in an optical storage device accessing the optical disc; and
a decision unit, coupled to the header appearance detection module, after the appearance of a first header of the at least one header is detected, the decision unit detecting whether there is another header's appearance in a window that lags behind the first header's appearance, wherein the decision unit determines whether the optical disc is a DVD-RAM disc according to the number of times that there is a header's appearance in a corresponding window.

14. The apparatus of claim 13, wherein the apparatus is substantially the optical storage device.

15. The apparatus of claim 13, wherein the apparatus is a circuit positioned in the optical storage device.

16. The apparatus of claim 13, wherein the reproduced signal carries information corresponding to the headers' appearances.

17. The apparatus of claim 13, wherein the reproduced signal corresponds to the reflected light of the main beam in the optical storage device.

18. The apparatus of claim 13, wherein the reproduced signal corresponds to the reflected light of the side beam in the optical storage device.

19. The apparatus of claim 13, the header appearance detection module further comprises:
a slice level generator for generating a slice level signal; and
a comparator, coupled to the slice level generator, for comparing the reproduced signal with the slice level signal to generate a reference signal corresponding to the reproduced signal;
wherein the reference signal represents the detection result of the at least one header's appearance.

20. The apparatus of claim 13, wherein after the first header's appearance is detected, if there is a second header's appearance in the window that lags behind the first header's appearance, the decision unit detects whether there is another header's appearance in a window that lags behind the second header's appearance.

21. The apparatus of claim 20, wherein the decision unit determines the window that lags behind the second header's appearance according to the interval between the first header's appearance and the second header's appearance.

22. The apparatus of claim 13, wherein the decision unit determines the window that lags behind the first header's appearance according to the rotational speed of the optical disc and the location of an optical pickup of the optical storage device.

23. The apparatus of claim 13, wherein regarding each window for detecting whether there is a header's appearance in the window, the decision unit determines the window according to the rotational speed of the optical disc and the location of an optical pickup of the optical storage device.

24. The apparatus of claim 13, wherein the decision unit determines whether the optical disc is a DVD-RAM disc according to the number of times that there is no header's appearance in a window.

25. The apparatus of claim 13, wherein the decision unit determines whether the optical disc is a DVD-RAM disc according to the number of subsequently detected headers' appearances.
